(19) United States
(12) Patent Application Publication
(10) Pub. No.: US 2017/0327913 A1
(43) Pub. Date: Nov. 16, 2017

(54) Device for Inserting a Refractory Block Into a Taphole Structure of a Metallurgical Vessel, in Particular a Basic Oxygen Furnace, and a Method for an Automatic Supply of the Refractory

(71) Applicant: Refractory Intellectual Property GmbH & Co. KG, Wein (AT)

(72) Inventor: Colin Cartmill, East Goulais River (CA)

(73) Assignee: Refractory Intellectual Property GmbH & Co. KG, Wein (AT)

(21) Appl. No.: 15/527,747

(22) PCT Filed: Nov. 3, 2015
(86) PCT No.: PCT/EP2015/075621

§ 371 Date: May 18, 2017

(30) Foreign Application Priority Data
Dec. 22, 2014 (EP) 14199838.5

(51) Int. Cl. C21C 5/44; F27D 3/15; C21B 7/12

(52) U.S. Cl. CPC C21C 5/445; F27D 3/1536; C21B 7/12

(57) ABSTRACT

A device is provided for inserting a refractory block (20) into a taphole structure (10) of a metallurgical vessel, in particular a basic oxygen furnace (BOF). The refractory block (20) is carried by a mounting unit (25) and having a proximate end (26), which can be introduced into the taphole. A distal end (27) with locking elements (28), which can be coupled to a locking plate (31) of the vessel, is disposed at the outside of the taphole (21) of the vessel (11). The refractory block (20) can be introduced into the taphole structure (10) until the locking elements (28) of the mounting unit (25) can be attached to and coupled with the coupling head (30) with a manipulator. This mounting unit (25) can be respectively uncoupled also with the manipulator, when the refractory block (20) is mortared and fixed in the lining (12), whereby the mounting unit (25) can be decoupled and removed solely out of the taphole (21). That enables the refractory block replacement and the gunning of refractory material from the inside of the furnace more easily.

The Invention refers to a device for inserting a refractory block into a taphole structure of a metallurgical vessel, in particular a basic oxygen furnace (BOF), whereby the refractory block is carried by a mounting unit and having a proximate end, which can be introduced into the taphole and a distal end with locking elements, which can be coupled to a locking plate disposed at the outside of the taphole of the vessel; and a method for an automatic supply of refractory.

Basic Oxygen Steelmaking is a process which employs the injection of oxygen into molten carbon-rich iron to obtain steel with relatively low-carbon content. The iron is processed in a furnace or, more specifically, in a Basic Oxygen Furnace (BOF) having a stout, oblong body lined with refractory material. The BOF is equipped with a taphole structure used for pouring of the finished molten steel through a tapping channel. The taphole structure comprises a tube-shaped removable refractory block consisting of several one after another equipped nozzles that forms in the mounted position the tapping channel which extends from the interior of the furnace and terminates in a casting or turret area of the furnace. Between the refractory block and a surrounding mantle of refractory material an annular gap is defined, which is filled with mortar or the like.

Due to wearing of the refractory block and it's lining refractory material, the refractory block must be removed and replaced relatively often, for example after about 40 to 120 tapping with each by emptying of the melt in the vessel.

The document DE-A-10 2010 056 117 discloses a handling of the replacement of a refractory block from the furnace's exterior. A filling opening, which is formed by a sleeve made of refractory material used in a perforation of the tapping channel with radial clearance, where the ring gap formed by the radial clearance is filled with refractory filler material. The sleeve exhibits an end of first circumferential collar located in the perforation of the tapping channel. The tapping channel near its target position facing the interior of the furnace, which bears the annular gap-bridging at the hole face of the hole provided with the sleeve at its outer end with a stopper-forming second collar and exhibits covered through-holes in the region of the annular gap. The refractory filler material for the annular gap is introduced through the perforations in the annular gap. With such a kind of filling of a viscous refractory material there exists the risk that the annular gap will not be filled completely.

Moreover a further important disadvantage exists in the fact that the inserting and positioning of the sleeve inside the tapping channel with the manipulator is connected with a difficult handling to reach an exact coaxial placement of the sleeve inside the channel.

The object underlying this invention is to avoid this disadvantage and to provide a device for inserting a refractory block into a taphole by avoiding any manual work and to easily locking respectively removing the mounting unit from the vessel.

This object is achieved according to the invention in that the refractory block can be introduced into the taphole until the locking elements of the mounting unit can be attached to and coupled with the coupling head with a manipulator, respectively uncoupled also with the manipulator, when the refractory block is mortared and fixed in the lining, whereby the mounting unit can be decoupled and removed solely out of the taphole.

Very advantageously, after the fastening of the locking elements at the locking plate the refractory block is positioned inside the lining in such a way, that it is surrounded by an annular gap, so that a filling material, like mortar, can be filled into this annular gap at least from the inside of the vessel.

The replacement of a refractory block of a taphole assembly is thus an arduous and dangerous task. There is therefore a need for, and it would be advantageous to have a configuration that enables the refractory block replacement and the gunning of refractory material from the inside of the furnace more easily.

In the following the invention is described in more detail by means of an exemplary embodiment with reference to the drawings. These are shown as follows:

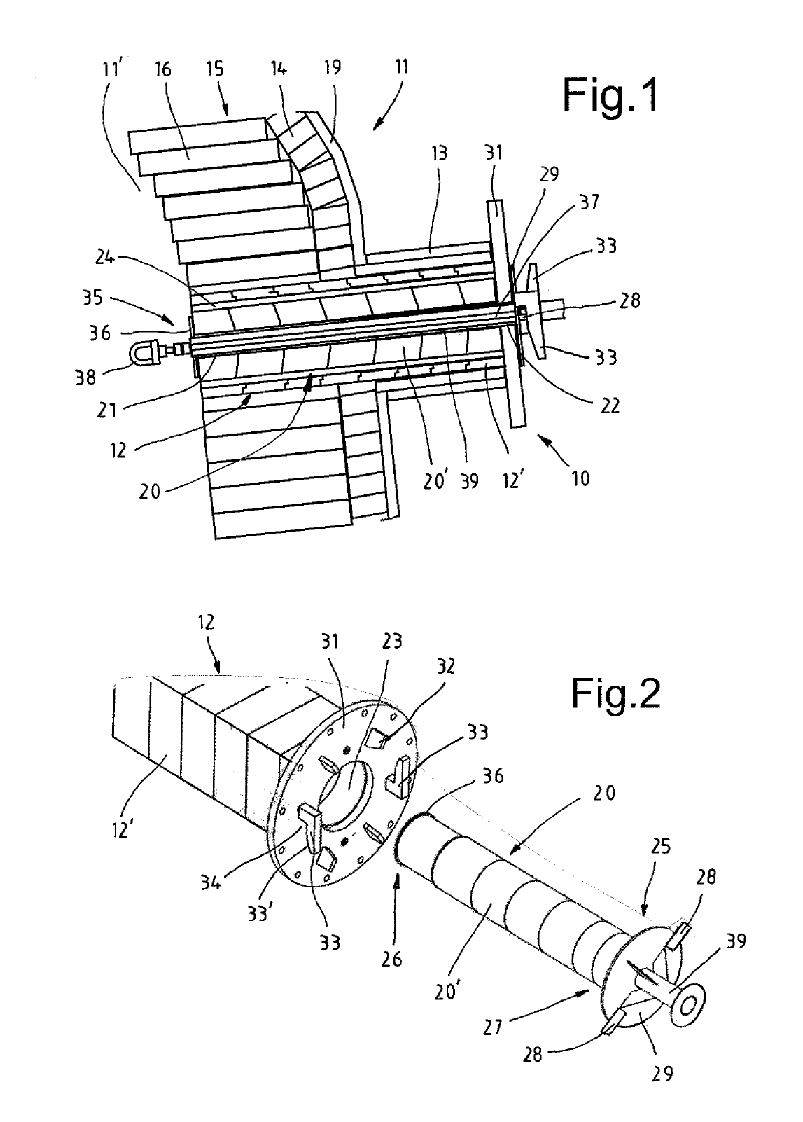

FIG. 1 a schematic cross-sectional view of a part of a BOF and its taphole structure; and

FIG. 2 a schematic perspective view of a taphole structure without vessel in a disassembled state of the refractory block, according to an embodiment.

FIG. 1 shows a taphole structure 10 of a metallurgical vessel 11, in particular of a basic oxygen furnace (BOF). The vessel 11 is shown as BOF but it could also be used a different type like an electric arc furnace, a ladle or the like for molten steel or other molten non-ferrous metals.

The vessel 11 in essence consists of an outer steel mantle 19 and a refractory lining 15 with refractory bricks 14 inside the mantle 19 and furthermore a second lining of bricks 16. The taphole structure 10 of the BOF is usually arranged at the upper side wall and for the tapping of the steel melt the BOF will be overturned. Advantageously a protruding neck 13 with a steel mantle 19 is used, where a refractory block 20 with the taphole 21 is inserted and is extending through the protruding neck 13 till the inside 11′ of the BOF. Therewith also an outlet 22 of the taphole 21 at the end of the protruding neck 13 is respectively provided, where the metal melt will flow out.

Furthermore it is indicated inside the taphole 21 a clamping mechanism 35 of a mounting unit 25, which has a fitting bolt 37 within a tube 39 and a disc 36. The fitting bolt 37 and the tube 39 extend through the tap hole and are mounted with one end at the mounting unit 25 outside and with the other end at the inside 11′ of the BOF, where a holding element 38 is provided. This clamping mechanism 35 thereby connects the refractory block 20 to the mounting unit 25 and holds the refractory nozzles 20′ together as a jetblock assembly.

According to FIG. 2 the refractory block 20 is carried by this mounting unit 25, which are moveable assembled by a not shown manipulator or a robot. The refractory block 20 having a proximate end 26, which can be introduced into the opening 23 of the lining 12. An opposite distal end 27 with the mounting unit 25 with locking elements 28 and a flange disc 29 can be coupled to a coupling head 30 after inserting the refractory block 20 into the lining 12. This coupling head 30 have a locking plate 31 with coupling elements 32, 33 disposed at the front side of the protruding neck 13.

According to the invention the refractory block 20 can be introduced into the taphole structure 10 until the locking elements 28 of the mounting unit 25 can be attached to and coupled with the coupling head 30 with the manipulator, respectively uncoupled also with the manipulator, when the refractory block 20 is mortared and fixed in the lining 12 and the mounting unit 25 can be decoupled and removed solely out of the discharge 21.

After the fastening of the locking elements 28 at the coupling head 30 the refractory block 20 is positioned inside the lining 12 in such a way, that it is surrounded by an annular gap 24, so that a filling material, like mortar, can be gunned into this annular gap 24 at least from the inside of the vessel. Thereafter the filling material is reinforcing respectively drying and fixing the refractory block 20 inside the lining 12, whereby this drying time takes approximately 5 to 10 minutes. Afterwards the mounting unit 25 can be removed solely without the refractory block by the manipulator.

The manipulator can be handled and driven by the staff in a conventional manner but it could also be used a robot, with which the handling for the supply of the refractory block 20 and all the necessary steps would be completely automated.

At this fastened position the disc 29 of the mounting unit 25 is in contact with the front side of the locking plate 31 of the coupling head 30. This locking plate 31 has a plurality of hooks 33 circularly arranged at the outside of the protruding neck 13 and the locking elements 28 having corresponding plurality of bars circularly arranged on the flange disc 29 of the mounting unit 25. The four arranged coupling elements 32 on the circumference of the opening 23 form a circle and serve as centring for the flange disc 29.

The L-shaped hooks 33, from which are used two oppositely placed to the taphole, form each a recess 34 and having a ramp 33′, in which the corresponding bar of the locking elements 28 at the periphery of the flange disc 29 can be introduced by swivelling of the mounting unit 25 around the axis of the taphole, thus with the not shown manipulator. The recesses 34 and the bars are dimensioned so that they can be coupled like a bayonet.

The plurality of hooks 33 have the same orientation with respect to a given first rotational direction and are arranged at a distance from each other matching the arrangement of locking bars, for allowing locking bars to form-fittingly engage with their respective hooks 33 through rotational movement of the refractory block 20 and the mounting unit 25 relative to the lining 12. Clearly, the rotational movement shall be in correspondence with the pointing direction of the hooks 33 for allowing the form-fitting engagement.

The plurality of the hooks 33 may be equidistantly arranged from each other so that each angle formed between two neighboring hooks may be about equal. Correspondingly, the plurality of bars are also equidistantly arranged from each other so that each angle formed between two neighboring bars may be about equal. The two hooks 33 are located opposite each other forming an angle of 180° between each other and, therefore, the two bars are also located opposite each other, forming an angle of 180° between each other.

In another embodiment the locking plate 31 may have more than two hooks 33 arranged thereon and the flange disc 29 may, respectively, have more than two bars arranged thereon. For example, three hooks and three bars (not shown) may be arranged on locking plate 31 and flange disc 29, respectively, at a distance forming for example an angle of about 120° between each other.

The hooks 33 are tapered towards their respective free ends such that the space between locking plate 31 and the L-shaped hook gradually increases towards the free ends. This configuration may facilitate the slidable rotation of bars underneath a hook for interlockingly engaging locking plate with the flange disc.

With a further embodiment of the Invention the bayonet could also be designed in the sense that the L-shaped hooks would be fixed at the outer side of the flange disc also with an extension tangentially and the locking elements would be fixed at the locking plate, what is not shown. With the coupling, when the refractory block is inserted and the mounting unit will be turned, the hooks and the locking elements would then respectively couple in a corresponding arrangement.

1. A device for inserting a refractory block into a taphole structure of a metallurgical vessel, in particular a basic oxygen furnace (BOF), whereby the refractory block (20) is carried by a mounting unit (25) and having a proximate end (26), which can be introduced into the taphole (21) and a distal end (27) with locking elements (28), which can be coupled to a locking plate (31) disposed at the outside of the taphole (21) of the vessel (11), wherein the refractory block (20) can be introduced into the taphole structure (10) until the locking elements (28) of the mounting unit (25) can be attached to and coupled with the coupling head (30) with a manipulator or a robot, respectively uncoupled also with the manipulator or the robot, when the refractory block (20) is mortared and fixed in the lining (12), whereby the mounting unit (25) can be decoupled and removed solely out of the taphole (21).

2. The device according to claim 1, characterized in that after the fastening of the locking elements (28) at the locking plate (31) the refractory block (20) is positioned inside the lining (12) in such a way, that it is surrounded by an annular gap (24), so that a filling material, like mortar, can be filled into this annular gap (24) at least from the inside of the vessel (11).

3. The device according to claim 1, wherein the locking plate (31) of the coupling head (30) has a plurality of circularly arranged hooks (33) at the outside of the taphole (21), and the locking elements (28) having corresponding plurality of bars circularly arranged on a flange disc (29) of the mounting unit (25).

4. The device according to claim 3, characterized in that after the attachment of the flange disc (29) and the locking elements (28) against the locking plate (31) the locking elements (28) will be swiveled by the manipulator so that the mounting unit (25) is fixed.

5. The device according to claim 3, characterized in that the coupling elements (32) on the circumference of the opening (23) form a circle and serve as centring for the flange disc (29) of the mounting unit (25).

6. The device according to claim 3, characterized in that L-shaped hooks (33), from which are used at least two oppositely placed to the taphole (21), form each a recess (34) and having a ramp (33′) in which the corresponding bar of the locking elements (28) at the periphery of the flange disc (29) can be introduced by swivelling of the mounting unit (25) around the axis of the taphole, thus with the manipulator or the robot.

7. The device according to claim 6, characterized in that the recesses (34) and the bars of the locking elements (28) are dimensioned so that the mounting unit (25) can be attached to and coupled with the coupling head (30) like a bayonet.

8. Method for an automatic supply of refractory in a taphole structure of a metallurgical vessel, in particular a basic oxygen furnace (BOF), where a mounting unit (25) with the refractory block (20) will be introduced into the taphole (21) by a manipulator or a robot, with which the refractory block (20) will be positioned inside the lining (12) in such a way, that the refractory block is surrounded by an annular gap (24), so that a filling material, like mortar, can be filled into this annular gap (24) at least from the inside of the vessel (11), and when the refractory block (20) is fixed in the lining (12), the mounting unit (25) will be removed solely by the manipulator or the robot.

9. Method according to claim 8, wherein the mounting unit (25) will be coupled to respectively uncoupled from the coupling head (30) of the vessel (11) with the manipulator or the robot.

10. The device according to claim 2, wherein the locking plate of the coupling head has a plurality of circularly arranged hooks at the outside of the taphole, and the locking elements having corresponding plurality of bars circularly arranged on a flange disc of the mounting unit.

11. The device according to claim 10, wherein after the attachment of the flange disc and the locking elements against the locking plate, the locking elements will be swiveled by the manipulator so that the mounting unit is fixed.

12. The device according to claim 10, wherein the coupling elements on the circumference of the opening form a circle and serve as centering for the flange disc of the mounting unit.

13. The device according to claim 10, wherein L-shaped hooks, from which are used at least two oppositely placed to the taphole, form each a recess and having a ramp in which the corresponding bar of the locking elements at the periphery of the flange disc can be introduced by swivelling of the mounting unit around the axis of the taphole, thus with the manipulator or the robot.

14. The device according to claim 13, wherein the recesses and the bars of the locking elements are dimensioned so that the mounting unit can be attached to and coupled with the coupling head like a bayonet.
